(19) United States
(12) Patent Application Publication
(10) Pub. No.: US 2012/0316822 A1
(43) Pub. Date: Dec. 13, 2012

(54) MOVEMENT MONITOR AND USE

(76) Inventors: Frank Barth, Tamm (DE); Christian Maeurer, Aachen (DE)

(21) Appl. No.: 13/513,394

(22) PCT Filed: Oct. 27, 2010
(86) PCT No.: PCT/EP10/66204

§ 371 Date: Aug. 20, 2012

(30) Foreign Application Priority Data
Dec. 4, 2009 (DE) 10 2009 047 474.9

(51) Int. Cl. G01P 15/18; G06F 15/00

(52) U.S. Cl. 702/138; 702/141

(57) ABSTRACT

In a movement monitor, at least one sensor for determining the acceleration and altitude differences is provided in addition to at least one sensor for determining location information. These sensors are linked in such a way that they are suitable for determining the energy conversion during a movement.

### FIELD OF THE INVENTION

The present invention is based on a movement monitor which includes at least one sensor for determining location information, and at least one sensor for determining the acceleration.

### BACKGROUND INFORMATION

A movement monitor is known from Japanese No. JP-10153442-A.

Lack of physical activity is a basic problem that is closely linked to the modern lifestyle. For this reason an attempt is made to motivate people to take up physical activity early enough and to a sufficient extent. This should already commence in early adulthood. People are best able to be motivated especially if feedback about the success of the physical activity is given quickly, possibly immediately. For this reason the German Ministry of Health, for example, had the idea of providing people with simple step counters, which supply feedback about the steps taken in the course of a day. However, these devices are only of limited use since they frequently measure incorrectly and are unable to distinguish between movement patterns (running, walking, climbing stairs, bicycling, etc.).

From PCT International Patent Publication No. WO 2007/000 282, a method is known which determines the energy conversion of a person while moving, on the basis of an acceleration sensor and a temperature sensor. The type of movement is detected there as well.

In Japanese No. JP-2000325329-A, an acceleration sensor and a gyroscope are provided in order to determine the type of movement by measuring the angle and the speed of the leg.

### SUMMARY OF THE INVENTION

Using at least one sensor for determining the acceleration and altitude differences, in addition to at least one sensor for determining location information, movement patterns, e.g., stair climbing, bicycling and other activities that are performed mostly without taking steps, are able to be detected better than when using movement monitors based solely on inertial sensors. Thus, movement states are able to be classified, which provides a more realistic picture of the energy conversion.

Due to the combination of sensors according to the present invention, data are provided that conventional movement monitors are unable to supply such as the acceleration, exact travel length and altitude difference, for example. This allows the construction of movement monitors that are not necessarily dependent upon the use of inertial sensors.

A GPS sensor may preferably be provided as a sensor for the location information or the analysis of GSM network information. In conjunction with the analysis of the acceleration, much more precise acceleration values result here than with a conventional inertial sensor (rate-of-rotation sensor, acceleration sensor).

A pressure sensor, which provides very precise values in connection with the provided location information is advantageously provided as a sensor for the altitude difference.

It is advantageous to combine the output signals of the sensors with the aid of a linking and evaluation unit in such a way that a classification of the movement state according to movement patterns is possible. A movement activity added up over time is able to be determined from this classification and from the output signals of the sensors. A wearer of the movement monitor thus always obtains reliable feedback about his or her actual activity so far, e.g., the daily activity, via a corresponding display. The exact determination of the activity is essential for high acceptance of the device on the part of the wearer. This is the only way of increasing the chances of success with regard to preventing or reducing inactivity.

Furthermore, the wearer is able to obtain information that until now was beyond the capabilities of movement monitors: height or else acceleration. In particular the acceleration is of great importance for deriving the converted (expended) energy. The expended energy increases quadratically with the acceleration. Thus, a bicyclist who accelerates rapidly uses considerably more energy in the acceleration phase than another person who accelerates more slowly. The result of this endeavor of faster acceleration thus is immediately available to the wearer.

It is advantageous to integrate the movement monitor into a navigation device, a mobile phone, or a PDA. This makes it possible to co-utilize the electronics of this device for obtaining location information. The display may be co-utilized as well. Due to the great acceptance of these devices, there is also an increased willingness to actually use the movement monitor. These devices may provide feedback to the user in an uncomplicated manner, for example about his daily activity or the current value of his or her energy conversion. It is also possible that a mobile telephone provider offers an additional pay-for-use service which makes these data available to the user in processed form.

### BRIEF DESCRIPTION OF THE DRAWING

FIG. 1 shows a circuit diagram of the movement sensor according to an exemplary embodiment of the present invention.

### DETAILED DESCRIPTION

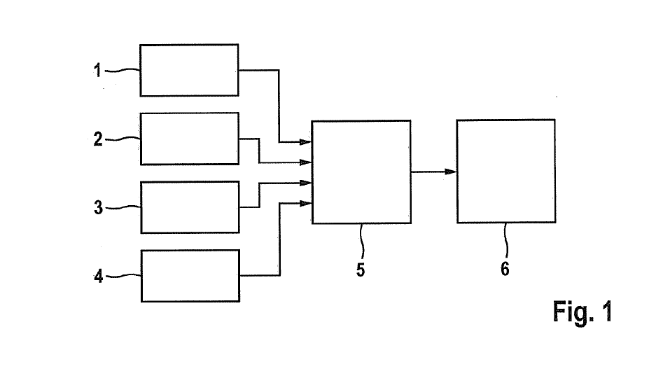

FIG. 1 shows a movement monitor having various sensors 1, 2, 3, 4, which are connected to a linking and evaluation unit 5. The result of the linkage and evaluation is forwarded to a display 6 or some other module for feedback of the energy conversion during movement to the wearer of the movement monitor. Sensor 1 for determining the location information may be a GPS (Global Positioning System), as currently used in navigation devices. This GPS information is available nearly everywhere. In addition to the GPS system, this location information may also be obtained from the soon to be available Galileo system. The GPS system provides very precise information about location, speed, acceleration and altitude. To determine the location information, the speed and acceleration, the network information from mobile telephony networks by means of sensor 2 may be utilized in addition in order to reconstruct a movement of a mobile telephone. However, the altitude is ascertainable only very roughly in this case. A pressure sensor 3, preferably an absolute pressure sensor, provides more precise altitude information. It makes altitude information available at excellent resolution and thus is able to detect stair climbing or running on an inclined surface. Sensor 4 is an inertial sensor. By suitable linking of the output signals of these sensors 1 through 4 by means of unit 5, it is possible to construct a very reliable movement monitor, in particular through redundancy validation of the physical quantities measured by different sensors. Suitable evaluation with the aid of unit 5 allows a classification of the movement type with regard to movement patterns. Each movement type is then assigned movement activities added up over time as a function of predefined metabolization values which may also take personal parameters such as weight into account, and as a function of the physical parameters such as covered distance, altitude difference, acceleration, the movement activities corresponding to the energy conversion, e.g., the daily activity of a person.

If all sensors 1 through 4 are provided and are also analyzed, a very reliable energy conversion is able to be determined. It is also possible to completely dispense with sensors such as the commonly utilized inertial sensor, for example.

Display 6 may represent the movement state and/or the movement activity added up over time as a measure for the energy conversion. Of course, it is also possible to provide some other type of feedback to the wearer of the motion sensor, such as a voice output in the manner of conventional navigation devices.

1-10. (canceled)

11. A movement monitor comprising:
at least one first sensor for determining an acceleration and altitude differences; and
at least one second sensor for determining location information,
wherein the first and second sensors are linked in such a way that they are suitable for determining an energy conversion during a movement.

12. The movement monitor according to claim 11, wherein a GPS sensor determines the location information.

13. The movement monitor according to claim 11, wherein GSM network information is analyzed for determining the location information.

14. The movement monitor according to claim 11, wherein an inertial sensor determines the acceleration.

15. The movement monitor according to claim 11, wherein a pressure sensor determines the altitude difference.

16. The movement monitor according to claim 11, further comprising a linking and evaluation unit for output signals of the sensors such that a classification of a movement state according to movement patterns is provided.

17. The movement monitor according to claim 16, wherein the linking and evaluation unit determines a movement activity added up over time from the classification and the output signals of the sensors.

18. The movement monitor according to claim 17, further comprising a display of at least one of the movement state and the movement activity added up over time.

19. The movement monitor according to claim 11, wherein the movement monitor is integrated into at least one of a navigation device, a mobile telephone, and a PDA.

20. The movement monitor according to claim 11, wherein the movement monitor is used for ascertaining the energy conversion of a person.
